(19) United States
(12) Patent Application Publication
(10) Pub. No.: US 2007/0013316 A1
(43) Pub. Date: Jan. 18, 2007

(54) Lampholder and lamp string device having an automatic bypass device

(76) Inventor: Kuei-Sun Peng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/181,930

(22) Filed: Jul. 15, 2005

(51) Int. Cl. H01J 7/44

(52) U.S. Cl. 315/59

(57) ABSTRACT

A lampholder and a lamp string device having an automatic bypass device are proposed. A Zener diode is provided in each lampholder. When the light bulb in a lampholder burns out or gets loose, the voltage across the two terminals of the Zener diode rises to the Zener breakdown voltage so that the Zener diode operates in the reverse region to replace the role of the original light bulb, hence keeping the whole circuit intact. Therefore, in the lampholder or the lamp string device having an automatic bypass device, the situation that one light bulb burns out or gets loose to cause the whole circuit to malfunction won't arise. The problem of continuous burnout of light bulb can also be avoided. Moreover, mass production can be accomplished to decrease the labor expenditure so as to effectively lower the overall cost.

### BACKGROUND OF THE INVENTION

1. Field of the Invention

The present invention relates to a lampholder and a lamp string device and, more particularly, to a lampholder and a lamp string device having an automatic bypass device.

2. Description of Related Art

A lamp string is a device with several light bulbs series connected together to the same power source. The current flowing through each light bulb is the same. The sum of the voltage of each light bulb equals the total voltage of the power source. The lamp string is turned on if a complete connection of the electric circuit is achieved. If any one light bulb burns out, the integrity of the electric circuit is destroyed. The whole lamp string thus cannot be turned on.

When the above situation occurs, it is only necessary to link the gap of the light bulb that burns out to turn on the lamp string again. In the prior art, this is accomplished in a mechanical way. The total load resistance of the electric circuit, however, will drop, hence increasing the total current. The voltage across each light bulb will also rise, hence increasing the temperature of the filament. Therefore, it is easier for the remaining light bulbs to burn out. Basing on this inference, a vicious circle is inevitable. When the filament of light bulb reaches an upper limit of the tolerable temperature, a continuous burnout of light bulb will happen.

Accordingly, the present invention proposes a lampholder and a lamp string device having an automatic bypass device to avoid the occurrence of continuous burnout of light bulb.

### SUMMARY OF THE INVENTION

An object of the present invention is to provide a lampholder and a lamp string device having an automatic bypass device. A diode is installed in each lampholder and is connected in shunt with the light bulb to span the same power source. Continuous burnout of light bulb due to an increase of the number of light bulbs that burn or get loose can be avoided.

Another object of the present invention is to provide a lampholder and a lamp string device having an automatic bypass device. The change time from when a light bulb burns out or gets loose to when the diode replaces its work is small, and the brightness changes little.

Another object of the present invention is to provide a lampholder and a lamp string device having an automatic bypass device, in which the characteristics of semiconductor devices such as small size, simple structure, and are fully exploited to lower the cost and save production material.

To achieve the above objects, the present invention provides a lampholder and a lamp string device having an automatic bypass device. The lampholder comprises a base and a diode. The base can fix a light bulb, and has two electrodes connected to a power source. The power source is used to turn on the light bulb. The diode is connected in shunt with the base to span the power source. The lamp string comprises several lampholders and several diodes. The lampholders are series connected together to a power source. Each lampholder can fix a light bulb, and has two electrodes connected to the power source. The power source is used to turn on the light bulbs. The diodes are located in the lampholders, and are connected in shunt with the lampholders to span the power source.

### BRIEF DESCRIPTION OF THE DRAWINGS

The various objects and advantages of the present invention will be more readily understood from the following detailed description when read in conjunction with the appended drawing, in which:

FIG. 1 is a structure diagram of a lampholder of the present invention; and

FIG. 2 is a circuit diagram of a lamp string of the present invention.

### DETAILED DESCRIPTION OF THE PREFERRED EMBODIMENTS

The present invention connects a diode in shunt with two electrodes of a lampholder. When the light bulb burns out or gets loose, the two electrodes will be connected via the diode to avoid affecting other light bulbs on the same series-connected circuit.

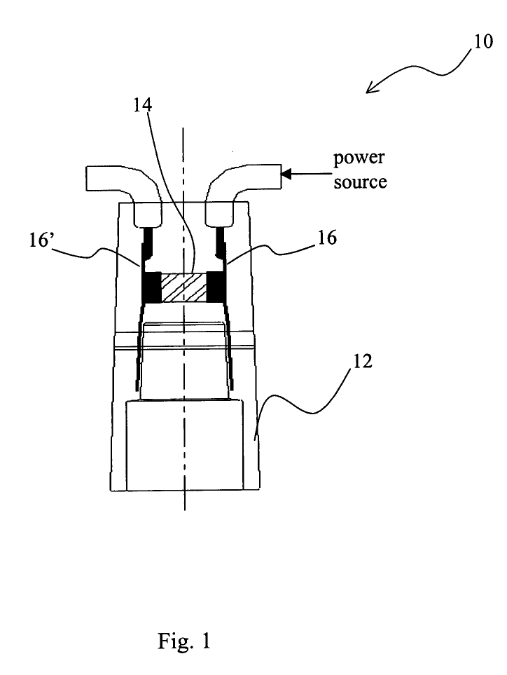

As shown in FIG. 1, a lampholder 10 comprises a base 12 and a diode 14. The base 12 has two electrodes 16 and 16′ to conduct a power source. After the power source is turned on, a light bulb (not shown) on the base 12 will be on. The power source is a DC power source or an AC power source. The diode 14 is connected in shunt with the base 12 to connect the power source. The diode 14 is a Zener diode or a bidirectional Zener diode.

The lampholder 10 will be exemplified below with an AC power source. When the diode 14 is a bidirectional Zener diode, its breakdown voltage (6.8 V) is about 20% higher than the voltage (5.5 V) of the lampholder 10. If the light bulb on the lampholder 10 burns out or gets loose, the voltage across the two ends of the bidirectional Zener diode rises to the Zener breakdown voltage so that the Zener diode operates in the reverse region (6.8 V) to replace the role of the original light bulb, hence keeping the whole circuit intact.

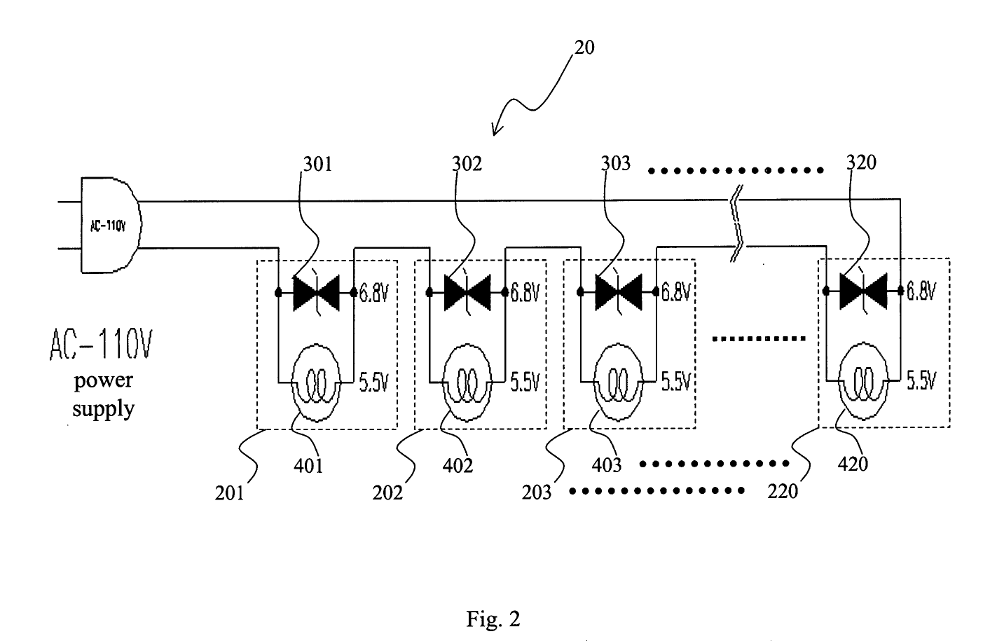

As shown in FIG. 2, a lamp string 20 is connected to an AC power source 110V. There are twenty lampholders 201-220 in the lamp string 20. Light bulbs 401-420 are installed in the lampholders 201-220, and connect in shunt with Zener diodes 301-320, as shown in FIG. 1. When no light bulb 401-420 burns out or gets loose, the voltage across each light bulb is 5.5 V. The power source is an AC power of 110 V
(a). If one light bulb burns out or gets loose, the voltage across each remaining light bulb is:
   (10V−6.8V×1)÷(20−1)=5.43V
(b). If two light bulbs burn out or get loose, the voltage across each remaining light bulb is:
   (110V−6.8V×2)÷(20−2)=5.35V
(c). If three light bulbs burn out or get loose, the voltage across each remaining light bulb is:
   (110V−6.8V×3)÷(20−3)=5.27V
(d). If six light bulbs burn out or get loose, the voltage across each remaining light bulb is:
   (110V−6.8V×6)÷(20−6)=4.94V
   Therefore, from the calculations of (a)-(d), when there is any light bulb that burns out or gets loose, the voltage across other remaining normal light bulbs will drop, hence making the remaining light bulbs more durable. Besides, when there are 30% of light bulbs that burn out or get loose, the variation of voltage is about 10%. The light bulbs can operate normally within ±10% of the normal rated voltage. With the increase of the number of light bulbs that burn out or get loose, the vicious circle of continual burnout of light bulb won't arise. Moreover, the change time from when a light bulb burns out or gets loose to when the diode replaces its work is small, and the change of voltage is about within 0.5%. The change of brightness of the remaining light bulbs cannot be perceived.

The present invention makes use of semiconductor diodes, which can be mass-produced and have a low price. The semiconductor diodes are suitable to ordinary lamp strings and low-price lamp strings. Moreover, the semiconductor diodes are small, and can be made in different shapes according to different applications. The semiconductor diodes can be installed in ordinary lamp strings that are slightly modified.

To sum up, the above diodes are connected in shunt with the light bulbs to the same power source to avoid the vicious circle of continual burnout of light bulb due to an increase of the number of light bulbs that burn or get loose. Therefore, the present invention can effectively solve the problem in the prior art that the lamp string is subject to the influence of part of its light bulbs. The present invention also provides an automatic connection mechanism without any mechanical movable part, hence having no trouble of bad contact. Besides, mass production can be accomplished, and the manufacturing cost is low.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A lampholder having an automatic bypass device comprising:
a base capable of fixing a light bulb and having two electrodes connected to a power source, said power source being used to turn on said light bulb; and
a diode connected in shunt with said base to span said power source.

2. The lampholder having an automatic bypass device as claimed in claim 1, wherein said power source is a DC power source or an AC power source.

3. The lampholder having an automatic bypass device as claimed in claim 1, wherein said diode is a Zener diode or a bidirectional Zener diode.

4. A lamp string device having an automatic bypass device comprising:
several lampholders series connected together to a power source, each said lampholder capable of fixing a light bulb and having two electrodes connected to said power source, said power source being used to turn on said light bulbs; and
several diodes located in said lampholders and connected in shunt with said lampholders to span said power source.

5. The lamp string device having an automatic bypass device as claimed in claim 4, wherein said power source is a DC power source or an AC power source.

6. The lamp string device having an automatic bypass device as claimed in claim 4, wherein said diodes are Zener diodes or bidirectional Zener diodes.
